(19) United States
(12) Patent Application Publication
(10) Pub. No.: US 2008/0198408 A1
(43) Pub. Date: Aug. 21, 2008

(54) Method of Controlling Computer and Printer for Printing System Capable of Executing Direct Printing

(75) Inventor: Kazuhiko Sugiura, Hekinan (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya (JP)

(21) Appl. No.: 12/034,920

(22) Filed: Feb. 21, 2008

(30) Foreign Application Priority Data
Feb. 21, 2007 (JP) 2007-041099

(51) Int. Cl. G06F 15/00

(52) U.S. Cl. 358/1.15; 358/1.16

(57) ABSTRACT

If a user wish to print files to be printed in accordance with a specific print setting, the user may store the file in a predetermined area of the external storage that is preliminarily associated with the predetermined print setting. When the printing device starts printing, files stored in the predetermined area are printed in accordance with the print setting associated to the predetermined area. Therefore, the printing device can reduce a user's burden in performing a relatively complicated print setting, while enabling print setting along with the user's demand.

### CROSS-REFERENCE TO RELATED APPLICATION

This application claims priority under 35 U.S.C. §119 from Japanese Patent Application No. 2007-041099 filed on Feb. 21, 2007. The entire subject matter of the application is incorporated herein by reference.

### BACKGROUND

1. Technical Field

The present invention relates to methods of controlling a computer and a printer for a printing system capable of performing direct printing.

2. Related Art

Conventionally, there is known a technique for reducing a user's burden in a setting operation of a complicated printing condition, by classifying each piece of image data stored in a record medium and storing print setting information, which is set for each of the classification, as a print setting file in the image record medium. An example of such a technique is disclosed in Japanese Patent Provisional Publication No. 2002-292941 (hereinafter, referred to as '941 publication).

### SUMMARY OF THE INVENTION

In a device disclosed in '941 publication, if Windows® is used as an operating system, since the image data files are classified by filenames or extensions, it is highly possible that all the files which have file names including the same character strings or extensions are printed using the same print setting.

However, the print setting should not be determined by a file name or an extension. Rather, it should be determined according to a demand of a user, or related to contents of the file to be printed. Therefore, the device disclosed in '941 publication may not execute printing using the print setting according to the demand of the user. In order for the user to obtain the desired printout which is formed in accordance with the demand of the user, the user is required to set the desired print setting to individual files. However, such a setting operation is troublesome, particularly when the number of files are relatively large.

In consideration of the above problem, the present invention is advantageous in that a user's burden in making a complicated print setting is reduced, while print setting according to the user's demand can be done easily.

According to aspects of the invention, there is provided a method for controlling a computer to store print data for direct printing to be executed by a printer in an external storage which is detachably connectable to the computer and the printer. The method includes the steps of judging whether the external storage is connected to the computer, acquiring type information regarding a print setting to be applied when the print data stored in the external storage is printed by the printer if the step of judging judges that the external storage is connected to the computer, determining an area in the external storage, in which area the print data is to be stored, based on the type information and predetermined association information defining a relationship between print settings and areas in the external storage, respectively, and storing the print data in the area determined by the step of determining.

According to aspects of the invention, there is provided a method of controlling a printer to execute a direct printing based on print data stored in an external storage which is detachably connectable to the printer and a predetermined print setting. The method includes the steps of judging whether the external storage is connected to the printer, first acquiring print data stored in the external storage if the external storage is connected to the printer, second acquiring the print setting based on an area of the external device in which area the print data is stored and predetermined association information defining a relationship between areas of the external device and print settings and printing the print data acquired in the step of acquiring with the print setting acquired in the step of acquiring.

According to other aspects of the invention, there is provided a printing system including a computer, a printing device and a detachable storage which is detachably connectable to the computer and the printing device. The printing system may includes an associating unit configured to associate a print setting with a storage area defined in the detachable storage, and a printing unit configured to print the file stored in the storage area based on the print setting associated to the storage area.

According to the methods and system configured as above, if a user wish to print files to be printed in accordance with a specific print setting, the user may store the file in a predetermined area of the external storage that is preliminarily associated with the predetermined print setting. When the printing device starts printing, files stored in the predetermined area are printed in accordance with the print setting associated to the predetermined area. Therefore, the printing device can reduce a user's burden in performing a relatively complicated print setting, while enabling print setting along with the user's demand.

### BRIEF DESCRIPTION OF THE ACCOMPANYING DRAWINGS

FIG. 1A is a block diagram schematically showing a printing system according to embodiments of the present invention.

FIG. 1B is a block diagram showing a configuration of a PC (personal computer) shown in FIG. 1A and an external device connectable to the PC.

FIG. 1C is a block diagram showing configuration of a printer of the printing system shown in FIG. 1A and the external device connectable to the printer.

FIG. 2 shows an example of a “background setup window” displayed on a display unit of the PC.

FIG. 3 shows an example of a “printer property window” displayed on the display unit of the PC.

FIG. 4 is a flowchart showing a first management process according to a first embodiment of the present invention.

FIG. 5 is a flowchart showing a second management process according to the first embodiment of the present invention.

FIG. 6 is a flowchart showing a control process according to a first embodiment of the present invention.

FIG. 7 is a flowchart showing a modified first management process according to the second embodiment of the present invention.

### DETAILED DESCRIPTION OF THE EMBODIMENT

Hereinafter, referring to the accompanying drawings, a printing system according to aspects of the invention will be described.

### First Embodiment

1. Outline of a Printing System

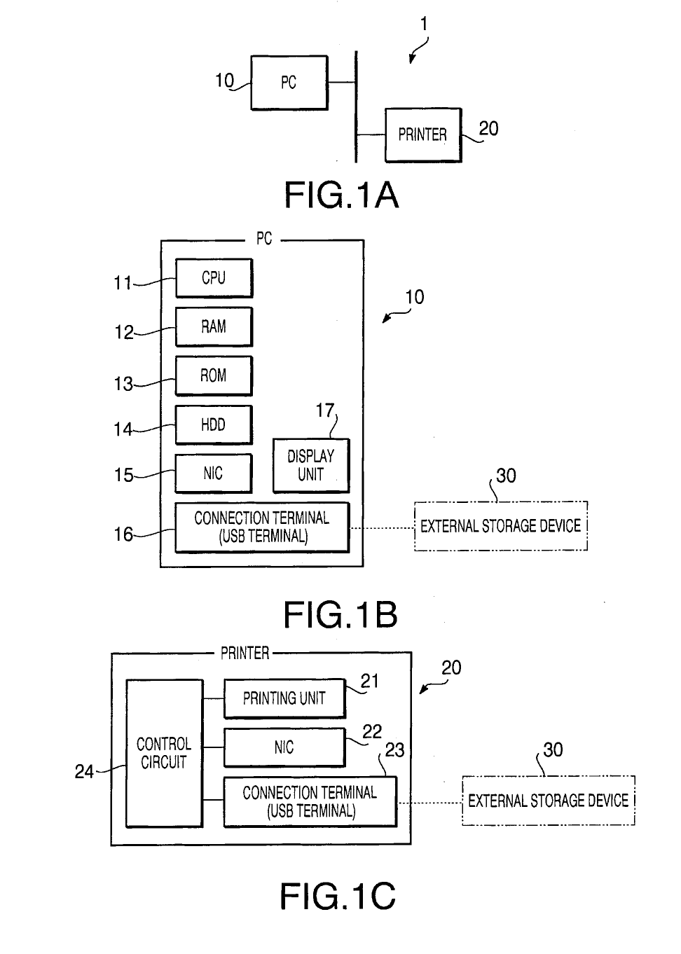

FIG. 1A is a block diagram of a printing system 1 according to the present invention. FIG. 1B is a block diagram showing a configuration of a PC (personal computer) 10 of the printing system 1, and an external storage 30 detachably connectable to the PC 10. FIG. 1C is a block diagram showing a configuration of a printer 20 of the printing system 1, and the external storage 30 which is also detachably connectable to the printer 20.

As shown in FIG. 1A, the printing system 1 is a system including the PC 10 and the printer 20 which are connected with each other via a network circuit such as an Ethernet®, via serial ports or parallel ports of the PC 10 and the printer 20. As shown in FIG. 1B, the PC 10 is provided with a CPU (Central Processing Unit) 11, a RAM (Random Access Memory) 12, a ROM (Read Only Memory) 13, a storage device such as an HDD 14, an NIC (Network Interface Card) 15, and a display unit 17, etc.

The PC 10 is further provided with a connection terminal 16 to which the external storage 30 is detachably connected. According to the embodiment, a connection terminal (interface) according to the USB (Universal Serial Bus) standard is adopted for the connection terminal 16. It should be noted that the connection terminal is not limited to the USB terminal, but a connection terminal according to another standard can be used.

The external storage 30 can be any storage which is provided with an interface connectable to the connection terminal 16. Specifically, a USB memory or an SD Memory® which are configured with non-volatile semiconductor memory such as a flash memory, or a magnetic storage device such as an HDD can be used as an external storage 30.

As shown in FIG. 1C, the printer 20 is provided with a printing unit 21 which forms images on record medium such as recording sheets, an interface to a network such as an NIC (Network Interface Card) 22, a connection terminal 23 to which the external storage 30 is detachably connectable and a control circuit 24 which controls an operation of the printing unit 21.

In the present embodiment, a connection terminal of the USB (Universal Serial Bus) standard is adopted for the connection terminal 23. However, the connection terminal is not limited to the USB standard, but a connection terminal according to another standard can be used.

The printer 20 has a so-called “direct printing” function which is a function to read out files stored in the external storage 30 connected to the connection terminal 23 and print images according to the read-out files, not through the PC 10.

It should be noted that a term “print file” means data in a specific format such as PDL (Page Description Language) format, which can be directly processed by the printer 20. In addition to the print files, the printer 20 according to the present embodiment can directly process image files such as BMP (Bit Map) format and JPEG (Joint Photographic Experts Group) format. Therefore, in the following description, the term “print files” refers to files which can be processed by the printer 20 (i.e., direct printing is enabled) including image files such as BMP files and JPEG files.

Incidentally, it is noted that, when printing is executed through the PC 10, if the user instructs printing, a printer driver is executed in the PC 10, and a file to be printed is converted into the print file by the printer driver. Then, the PC 10 (the printer driver) temporarily stores the print file in the particular area defined in the HDD 14 (hereinafter, the particular area will occasionally be referred to “spooler”), transmits the print file to the printer 20 depending on an operation status of the printer 20, and deletes the print file stored in the spooler when the printing is completed.

2. Printer Driver and Printing Program

2.1. Printer Driver

The printer driver is a kind of a printer management program which is installed in the PC 10 and works in cooperation with an OS (Operating System) of the PC 10. The printer driver is started when the user instructs to execute printing, or to start the printer driver.

Throughout the specification, description is made using Windows® as an OS. Accordingly, in the following description, terms which are not given specific descriptions (definitions) are used in general meaning in the field of “Windows.”

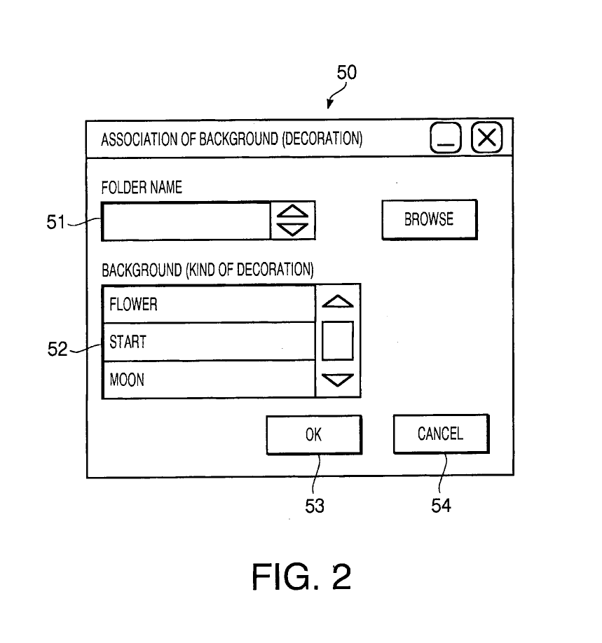

FIG. 2 shows an example of a “background setup window” 50 displayed on a display unit 17 (see FIG. 1B) of the PC 10 when the user instructs to start the printer driver. In the setup window 50, a dialogue is displayed for associating specific print setting such as a background and frame decoration (hereinafter, referred to simply “background”) with a specific folder where print files for direct printing are stored.

That is, in the background setup window 50, an entry field 51 of a “folder name” is an input section in which a folder name that is associated with the background is to be input. A selection box 52 of a “kind of a background (decoration)” is a selection section for selecting a background to be associated with the folder name input in the entry field 51.

Then, when a folder name is input or displayed in the entry field 51, if an OK button 53 is selected (clicked) after a desired background, which is displayed in the selection box 52, is selected by the user, the printer driver associates the folder name in the entry field 51 (hereinafter, referred to as an “associated folder name”) with the selected background (hereinafter, referred to as the “selected background”), and the relationship (association therebetween) is stored in the HDD 14 of the PC 10 as association information.

Specifically, the relationship is represented by a relation table which shows association between associated folders and selected backgrounds. Further, image data which represents the selected background is stored in the printer 20 so as to be used for direct printing in the present embodiment. However, such a configuration is an exemplary one, and, for example, the image data may be stored in both the printer 20 and the PC 10.

When a cancel button 54 is selected (clicked), the background setup screen 50 is closed without associating the folder name with the selected background.

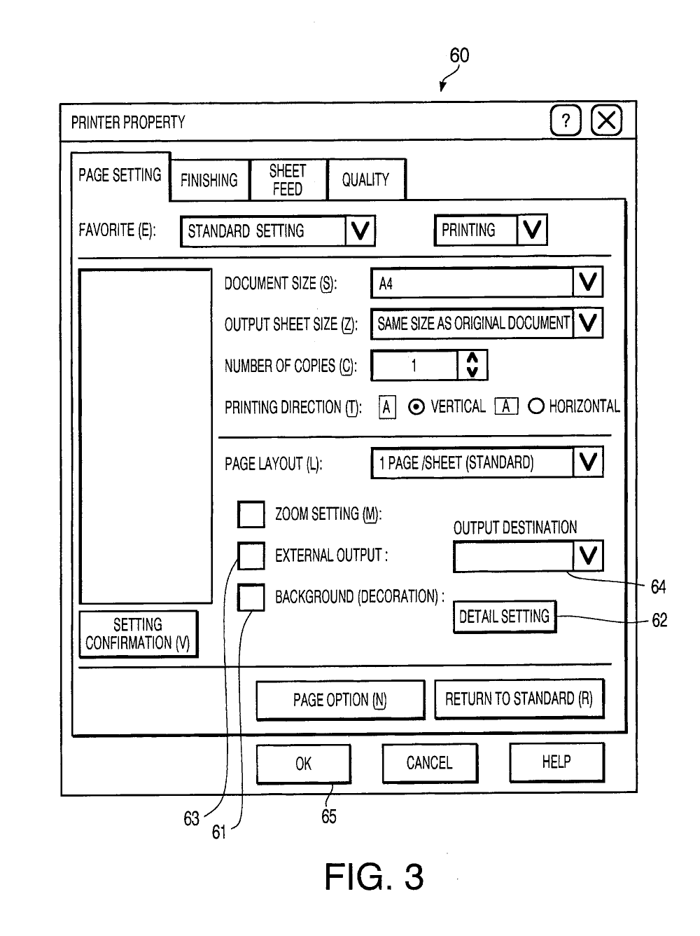

FIG. 3 shows an example of the property window 60 of the printer 20 displayed on the display unit 17 when the user instructs to execute printing. As shown in FIG. 3, in the property window 60, there is provided a check box 61 for selecting whether to make the association between an associated folder name and a selected background effective (i.e., whether to reflect the association between an associated folder name and a selected background in the printing operation).

A detail setting button 62 functions as a setup screen starting button. Upon selecting (clicking) the detail setting button 62, the background setup screen 50 is displayed. An external output check box 63 is checked when the user desires direct printing. That is, if the external output check box 63 is checked, the print files generated by the printer driver is transmitted to (stored in) a storage (e.g., the external storage 30) rather than the printer 20.

An output destination list box 64 is for selecting a storage in which a print file for direct printing should be stored when the external output check box 63 is selected and an external output is made effective.

As described above, in usual printing operations, the print file generated by the printer driver is transmitted to the printer 20 and printed. However, if the external output check box 63 is checked, the generated print file is stored in the destination storage indicated in the output destination list box 64.

Since other selection boxes displayed on the property window 60 or input boxes, etc. are of well-known function settings, a description thereof is omitted for brevity.

2.2 Printing Program

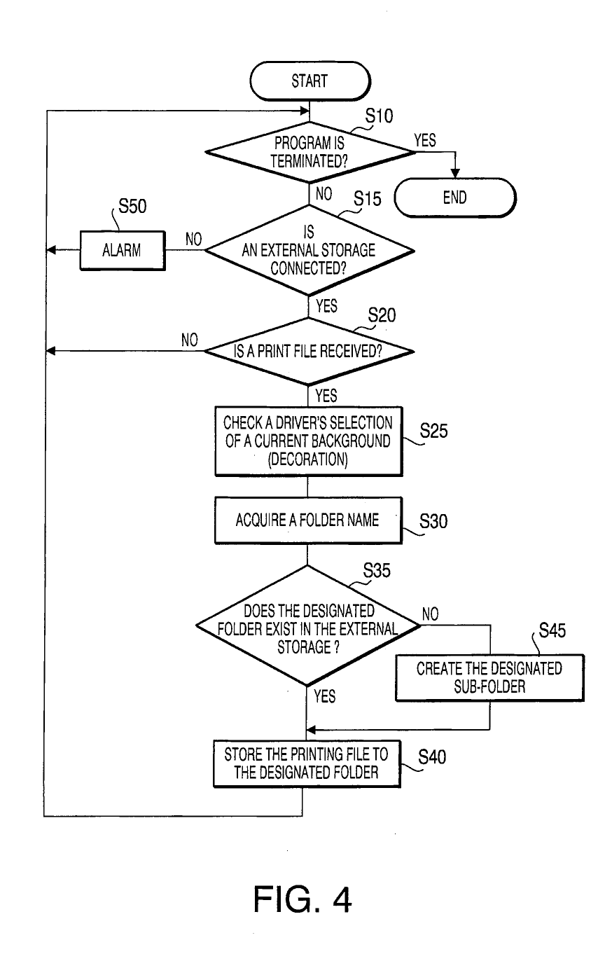

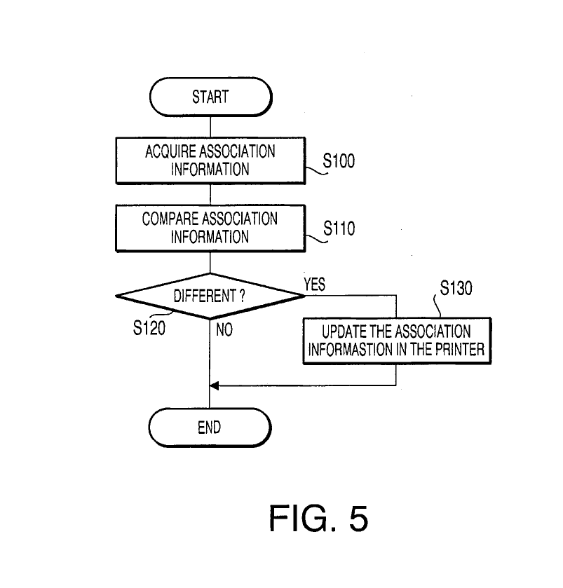

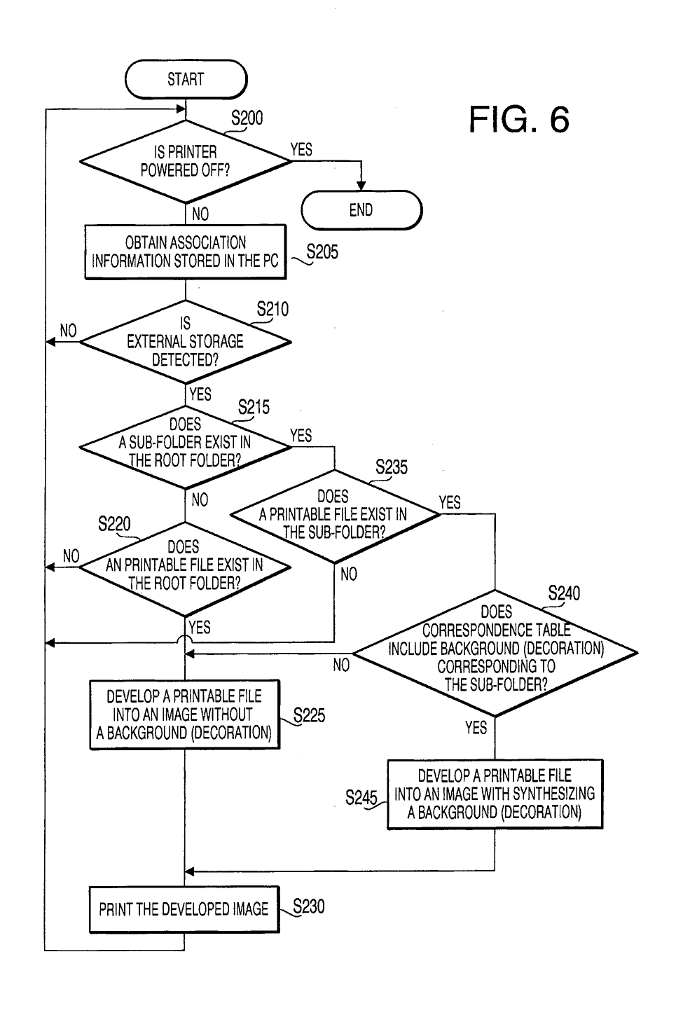

FIGS. 4-6 are flowcharts illustrating management processes according to the embodiment. The processes are performed as programs are executed by the CPU 11 of the printer 10. The programs include a program which is installed in the PC 10 as a part of the printer driver and works in cooperation with the OS (FIGS. 4 and 5), and a program which works in the printer 20 as a management program of the printer 20 (FIG. 6).

2.2.1. First Management Process (see FIG. 4)

FIG. 4 is a flowchart illustrating a first management process which is performed when a first management program is executed by the CPU 11 of the printer 10. The first management process is started when the OK button 65 (see FIG. 3) is clicked by the user on condition that the check boxes 61 and 63 are checked (see FIG. 3). After started, the first management process continues to be performed until the PC 10 is powered off or the user instructs to stop the first management process.

In the following description, for brevity, a case where the external storage 30 connected to the connection terminal 16 is selected as an output destination of the print file will be described as an example.

When the first management process shown in FIG. 4 is started, firstly, the process judges whether termination of the process is instructed by the user (S10). If the termination of the process has been instructed (S10: YES), the first management program is terminated.

If the termination of the process has not been instructed (S10: NO), the process judges whether the external storage 30 is connected to the connection terminal 16 (S15). If the external storage 30 is not connected (S15: NO), the process issues warning to the user to notify that the output destination cannot be detected (S50), and returns to S10.

If the process determines that the external storage 30 is connected (S15: YES), the process judges whether a print file is received (S20). If the print file has not been received (S20: NO), the process returns to S10.

If the process determines that the print file is received (S20: YES), a kind of currently selected background is retrieved from the HDD 14 (S25). Then, based on the association information stored in the HDD 14 and the selected background retrieved in S25, the process obtains a folder name in which the received print file (hereinafter, referred to “object print file”) is to be stored (S30).

Next, the process judges whether there exists a folder of which name is the same as that obtained in S30, that is, the associated folder in a root folder of the external storage 30 (S35). If the process determines that there exists the associated folder in the root folder of the external storage 30 (S35: YES), the process stores the object print file in the folder provided in the external storage 30 (S40), and the process returns to S10.

If the process determines that there is not the associated folder in the root folder of the external storage 30 (S35: NO), the process creates the associated folder in the root folder of the external storage 30 (S45), and process stores the object print file in the associated folder newly made in the external storage 30 (S40).

2.3. Second Management Process (see FIG. 5)

FIG. 5 is a flowchart showing a second management process which is performed when the CPU 11 of the PC 10 executes a second management program 2. The second management process is started when the PC 10 recognizes the printer 20, for example, when the printer 20 is connected to the PC 10, a connected printer 20 is powered on, or the like.

When the second management process shown in FIG. 5 is started, firstly, the process reads out the association information stored in the printer 20 (S100), and compares the read-out association information with association information stored in the PC 10 (HDD 14) (S110, S120).

If the process determines that there is no difference between the association information obtained in S100 and the association information stored in the PC 10 (HDD 14) (S120: NO), the management program 2 is terminated.

If the process determines that there is a difference between the association information obtained in S100 and the association information stored in the PC 10 (HDD 14) (S120: YES), the process updates the association information stored in the printer 20 to be equal to the association information stored in the PC 10 (HDD 14), thereby both of the association information coincide with each other (S130).

2.4. Control Program of the Printer (see FIG. 6)

FIG. 6 is a flowchart showing a control process which is performed when the control unit 24 of the printer 20 executes a control program (which is one of the print programs) according to the embodiment.

The control process shown in FIG. 6 is started when a power switch of the printer 20 is turned on and the printer 20 starts to operate. When the control process is started, the process judges whether the power switch of the printer 20 is turned off (S200).

If the power switch is turned off (S200: YES), the control process is terminated.

If the power switch is not turned off (S200: NO), after the association information stored in the PC 10 is retrieved (S205), the process judges whether the external storage 30 is connected to the connection terminal 23 of the printer 20, that is the process judges whether the external storage 30 is detected (S210).

If the external storage 30 is not detected (S210: NO), the process returns to S200. If the external storage is detected (S210: YES), the process judges whether there is a sub-folder in the root folder (S215).

If there is no subfolder in the root folder (S215: NO), the process judges whether a printable file (i.e., a print file) is stored in the root folder of the external storage 30 (S220). If no print file is stored in the root folder (S220: NO), the process returns to S200. If the print file is stored in the root folder (S220: YES), the print file is developed for printing without synthesizing a background (S225), and the developed file is printed (S230).

If there exists a sub-folder in the root folder (S215: YES), the process judges whether a print file is stored in the subfolder (S235). If no print file is stored in the subfolder (S235: NO), the process returns to S200.

If a print file is stored in the subfolder (S235: YES), based on the association information retrieved in S205, the process judges whether the background is associated with the current subfolder (S240).

Then, if the background is not associated with the current subfolder (S240: NO), the process develops the print file for printing without synthesizing the background (S225), and print the developed file (S230).

On the other hand, if it is determined that the background is associated with the object subfolder (S240: YES), the print file is synthesized with the background and developed for printing (S245), and the developed file is printed (S230).

In an environment where the PC 10 and the printer 20 are always connected to each other, it is sufficient that the image data of the background is held in at least one of the printer 20 and the PC 10.

In order to enable direct printing even in the printer 20 which is not connected to the PC 10, according to the embodiment, the image data of the background is stored at least in the printer 20. When the direct printing is executed, if the background is to be synthesized with the print file, the image data of the background stored in the printer 20 is retrieved and synthesized with the print file.

3. Features of a Printing Program According to the Embodiment

According to the present embodiment, based on a user's setting, the folder is associated with print settings such as a background and a decoration, and printing is executed based on the thus set print settings.

Therefore, if a user saves files (print object data) in the same folder, printing is carried out with the same print settings which are related to the folder. Thus, it is possible to reduce a user's burden of performing a complicated print setting operation while enabling the print settings in accordance with the user's demand.

Further, according to the present embodiment, if the association information stored in the PC 10 is different from that stored in the printer 20, an operation to make both the association information identical is automatically executed. Thus, it is possible to reduce a user's burden of setting an operation of a complicated printing condition.

### Second Embodiment

In the above described embodiment, the association information set by the printer driver is stored in storages (not shown) which is provided in the PC 10 and the printer 20. In the present embodiment, the association information and image data such as the background and decoration set by the printer driver may be stored also in the external storage 30.

If the image data such as the background and the decoration is stored in the external storage 30, when, for example, the direct printing is executed by the printer 20 which is not connected to the PC 10, it is not necessary to store the image data such as the background and the decoration in the printer 20.

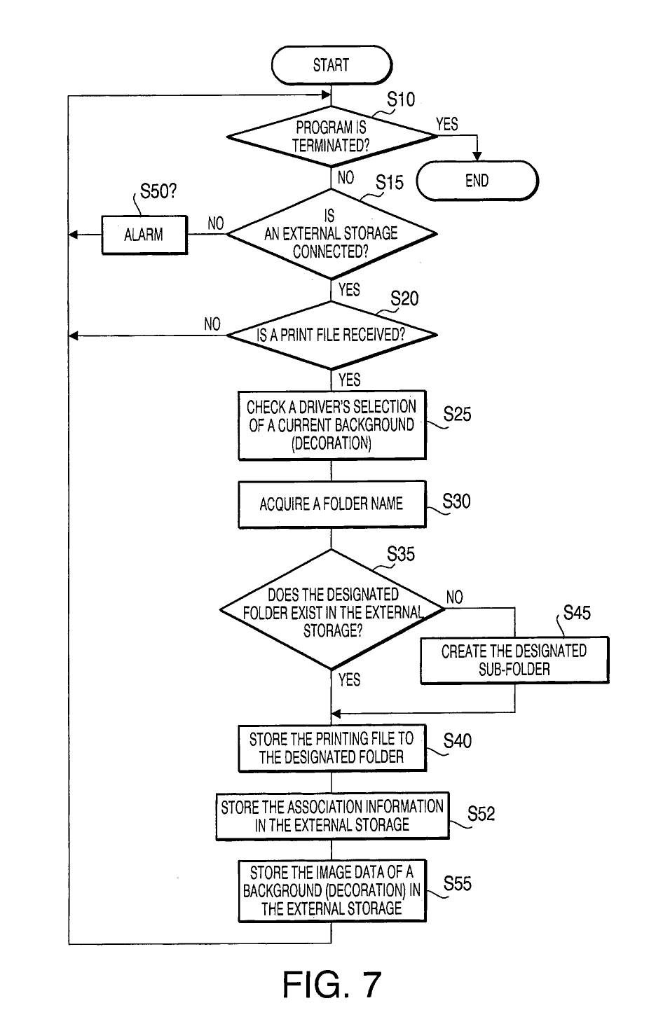

FIG. 7 is a flowchart showing a modified first management process. The modified first management process shown in FIG. 7 is started when the OK button 65 (see FIG. 3) is selected by the user with the check boxes 61 and 63 being checked, similarly to the first embodiment and the CPU 11 executes the program for executing the third management process.

As shown in FIG. 7, after the current print file is stored in the associated folder (S40), the association information stored in the HDD 14 and the image data of the background retrieved in S25 are stored in the external storage 20 (S52, S55), which is the only difference between FIG. 4 and FIG. 7.

According to the second embodiment, since the image data of the background is stored in the external storage 30, it is not necessary to store the image data of the background in the printer 20, and the print file can be printed with the image data stored in the external storage 30 being synthesized.

Further, in the second embodiment, the association information is stored in the external storage 30. By transferring the association information stored in the external storage 30 to the printer 20, the association information stored in the printer 20 can be reconciled with that stored in the PC 10.

According to the second embodiment, the first management process stores the association information and the image data of the selected background in the external storage 30. It should be noted that the configuration need not be limited to the above-described one, but can be modified such that the association information and the image data may be stored, when an OK button 53 is clicked, in any other device which can be accessed by the PC 10 using the external storage 30 or connected to the PC 10 via a network.

Further Modifications

In the above described embodiments, the present invention is described taking a print program as an example. The present invention is not limited to the above, but the printer 20 may be configured to realize the same function by itself.

Specifically, for example, the printer 20 may be configured to display a setting window similar to the setting window 50 shown in FIG. 2, and store the association information and the image data of the background set through the setting window in the external storage 30 connected to the connection terminal 23 of the printer 20.

Further, in the above described embodiments, the print settings for associating an image such as the background and/or decoration with a folder are described. However, the present invention need not be limited to such a configuration. The print setting may optionally or alternatively include any other content as long as the content is set through the printer driver. Accordingly, the content may be, for example, a setting of printing resolution, a setting of a watermark printing and a stamp printing, or a selective setting of black-and-white printing and color printing, associated to folders.

It should be stressed that the present invention is not limited to the above described embodiments. The embodiments can be modified in various ways without departing from the scope of the invention.

What is claimed is:

1. A method for controlling a computer to store print data for direct printing to be executed by a printer in an external storage which is detachably connectable to the computer and the printer, the method comprising the steps of:
judging whether the external storage is connected to the computer;
acquiring type information regarding a print setting to be applied when the print data stored in the external storage is printed by the printer if the step of judging judges that the external storage is connected to the computer;
determining an area in the external storage, in which area the print data is to be stored, based on the type information and predetermined association information defining a relationship between print settings and areas in the external storage, respectively; and
storing the print data in the area determined by the step of determining.

2. The method according to claims 1,
wherein the area in which the print data is to be stored is defined as a folder in the external storage.

3. The method according to claim 2,
further comprising the step of creating a folder if the folder in which the print data is to be stored does not exits in the external storage.

4. The method according to claim 1,
further comprising:
the step of judging whether the computer is connected to the printer;
if the computer is connected to the printer,
acquiring the association information stored in the printer;
comparing the acquired association information with the predetermined association information stored in the printer; and
updating the association information stored in the printer if the acquired association information and the predetermined association information stored in the computer do not coincide with each other, so that the association information stored in the printer coincides with the predetermined association information stored in the computer.

5. The method according to claim 4,
wherein the step of updating includes the step of transmitting the predetermined association information to the printer, the predetermined association information replacing the association information of the printer.

6. The method according to claim 1,
further comprising the step of storing the predetermined association information in the external storage if connected to the computer.

7. The method according to claim 6,
further comprising the step of storing data of the print setting to be used when the print data stored in the external storage is printed in the external storage.

8. The method according to claim 1,
wherein the type information regarding the print setting includes a kind of background image which is to be printed as the background of the image represented by the print data when the direct printing is executed by the printer.

9. The method according to claim 8,
further comprising the step of storing image data representing the background image in the external storage.

10. A method of controlling a printer to execute a direct printing based on print data stored in an external storage which is detachably connectable to the printer and a predetermined print setting, the method comprising the steps of:
judging whether the external storage is connected to the printer;
first acquiring print data stored in the external storage if the external storage is connected to the printer;
second acquiring the print setting based on an area of the external device in which area the print data is stored and predetermined association information defining a relationship between areas of the external device and print settings; and
printing the print data acquired in the step of acquiring with the print setting acquired in the step of acquiring.

11. The method according to claim 10,
wherein the areas of the external device are folders provided in a root folder.

12. The method according to claim 11,
wherein when the first acquiring step acquires the print data in the root folder, the second acquiring step acquires a predetermined print setting without referring to the predetermined association information.

13. The method according to claim 12,
wherein the predetermined print setting requires printing of the print data without a background image.

14. The method according to claim 11,
wherein when the first acquiring acquires the print data in a sub-folder in the root folder, the second acquiring step acquires the print setting based on the association information corresponding to the sub-folder.

15. The method according to claim 13,
wherein the predetermined print setting includes a setting of a background image, which is printed as a background when the print data is printed.

16. The method according to claim 10,
further comprising a third acquiring step of acquiring the predetermined associating information from a computer which is connected to the printer via a network.

17. The method according to claim 10,
wherein the predetermined association information is stored in the printer.

18. The method according to claim 10,
wherein the predetermined association information is stored in the external storage.

19. A printing system including a computer, a printing device and a detachable storage which is detachably connectable to the computer and the printing device,
the printing system comprising:
an associating unit configured to associate a print setting with a storage area defined in the detachable storage; and
a printing unit configured to print the file stored in the storage area based on the print setting associated to the storage area.
